(19) United States
(12) Patent Application Publication
(10) Pub. No.: US 2015/0115759 A1
(43) Pub. Date: Apr. 30, 2015

(54) Rotor Support and Method for Producing a Rotor Support

(71) Applicant: Daimler AG, Stuttgart (DE)

(72) Inventors: Martin Doeringer, Suessen (DE); Manfred Kempf, Vogt (DE); Hans-Guenther Merheim, Uhingen (DE)

(73) Assignee: Daimler AG, Stuttgart (DE)

(21) Appl. No.: 14/396,457

(22) PCT Filed: Jan. 29, 2013
(86) PCT No.: PCT/EP2013/000257

§ 371 Date: Oct. 23, 2014

(30) Foreign Application Priority Data
Apr. 24, 2012 (DE) 10 2012 008 015.8

(51) Int. Cl. H02K 1/27; H02K 15/14

(52) U.S. Cl. CPC H02K 1/2786; H02K 15/14
USPC 310/156.08; 29/596

(57) ABSTRACT

A rotor arm for an electrical machine includes a support pot for mounting a magnetic element. The support pot has a hub bearing a drive shaft. An inner peripheral surface of the rotor arm has, in an axial direction from the hub, an end stop for a supporting element of the rotor arm for the further bearing of the drive shaft.

### BACKGROUND AND SUMMARY OF THE INVENTION

Exemplary embodiments of the invention relate to a rotor arm for an electrical machine and a method for the production of a rotor arm.

Rotor arms for electrical machines and methods for their production are known. An electrical machine has a stator and a rotor, mounted for rotation within it, wherein an electromagnetic coupling between the rotor and stator can be produced, which ensures that either electrical energy supplied to electrical machine is converted into mechanical energy, or that mechanical energy supplied to the electrical machine is converted into electrical energy. The electrical machine therefore operates either as a motor or as a generator. In the process, it is possible that the same electrical machine, depending on the operating type, is used as a motor and as a generator. For example, this is known from the automobile sector, where it is possible, particularly in the field of hybrid vehicles or purely electrically driven vehicles, that the same electrical machine converts electrical power as a motor into driving power, wherein it can regain braking energy in another operating status by way of so-called recuperation and convert it into electrical energy. The rotor of an electrical machine typically comprises a rotor arm having a support pot, which serves for the mounting of at least one magnetic element. The magnetic element is also preferably formed as a stack of sheets, which, depending on the operational mode or the design of the electrical machine, has at least one electrical winding or at least one permanent magnet added to it. Several windings or permanent magnets are preferably provided—as seen in the peripheral direction—at constant angular distance. The at least one magnetic element can be provided on an outer peripheral wall of the support pot or also on its inner wall. The support pot has a hub to bear a drive shaft.

It is currently important in the automobile sector that an electrical machine is light, i.e., has particularly thin walls and has a high mechanical load capacity at the same time. Moreover, it is very important that the parts of the electrical machine are manufactured with high precision, large dimensional accuracy and low tolerance, as well as low clearance. Small variations in a predetermined clearance between the rotor and stator, which may even vary along the periphery, can lead to considerable performance losses of 30% or more of the power rating of the electrical machine. Imbalances also lead to corresponding performance losses. In particular, tolerances and imbalances due to tolerance also lead to considerable fluctuation of the performance of individual electrical machines manufactured in series, viewed across the entire series. In order to decrease the impact of tolerances and clearance, provision is preferably made to create the electrical machine out of as few parts as possible, in particular, therefore, to produce as many parts as possible in one piece.

German patent documents DE 103 58 456 A1 and DE 10 2010 010 269 A1 disclose producing a rotor arm for an electrical machine in one piece using flow forming. According to the technical teaching of German patent document DE 10 2010 010 269 A1, a semi-finished sheet is used as starting material as the basis for the flow forming method. This generally leads either to only a low mechanical capacity of the rotor arm, if this is formed with thin walls and is correspondingly light, or it leads to rotor arm that is formed with comparatively thick walls and is heavy, if this is formed with a high mechanical load capacity. According to the teaching of German patent document DE 103 58 456 A1, it has only been established that the rotor arm is produced from a metal material.

Moreover, it is evident that, for the known rotor arms, a drive shaft is only ever mounted or supported in the region of a hub of the rotor arm. It is therefore possible for imbalances to arise, in particular if the shaft is not perfectly aligned axially to the rotor arm. As a result of this, considerable performance losses of the electrical machine and series variations in the performance can occur.

Exemplary embodiments of the invention are therefore directed to a rotor arm and method for the production thereof, wherein performance losses and in particular performance variations of an electrical machine or a series of electrical machines, in which the rotor arm is used, are considerably reduced or avoided where possible. At the same time, the rotor arm is to have a high mechanical load capacity, but is to be formed with as thin walls as possible and to be as light as possible.

The rotor arm is characterized in that an inner peripheral surface of the support pot has, in an axial distance from the hub, an end stop for a supporting element of the rotor arm for further bearing of the drive shaft. The supporting element can be positioned on the end stop and comprises a bearing for the drive shaft, such that this is supported not only in the region of the hub, but also on a wider area spaced axially from the hub. As a result of this, imbalances are considerably reduced, preferably completely avoided. In particular, the supporting element enables a precise, coaxial arrangement of the drive shaft relative to the axis of symmetry of the support pot. Overall, performance losses of the electrical machine are avoided, and series variation is also reduced because, due to the precise bearing of the drive shaft, lower tolerances are given with regard to their arrangement.

The rotor arm is preferably provided for an electrical machine for use in a motor vehicle, in particular a hybrid vehicle or an electrically driven vehicle.

The end stop is preferably formed as a recess. This is preferably formed as a layered recess, on which the supporting element is mounted. The support pot comprises—as seen in the axial direction—a substantially stabilized inner diameter, which increases in the region of the recess on a side thereof turned away from the hub, such that a ledge is formed here. The ledge is preferably formed circumferentially, as seen in the peripheral direction, and the supporting element is in contact with the ledge in the assembled state. This results in particular in a stable arrangement of the supporting element, such that the bearing for the drive shaft is also constantly in exact alignment.

Alternatively, it is also possible for the end stop to comprise several recesses and/or protrusions provided on an inner wall of the support pot, which are preferably arranged at equal angular distance from one another, at the same level and in the axial direction. A stable attachment of the supporting element to the end stop is also possible in this way.

The supporting element is preferably formed as a supporting disc. Alternatively, it is also possible for the supporting element to be formed in a star shape.

A bearing can preferably be inserted into the hub of the support pot, in particular a roller or needle bearing, in which the drive shaft is mounted to pivot relative to the support pot. The hub comprises a retainer on a side facing an interior of the support pot, preferably a toothing system, to fasten a clutch, which is preferably formed as a multiple disc clutch. This is connected to the drive shaft on the output side. A torsional moment can be transferred by the rotor arm to the drive shaft when the clutch is engaged. Naturally, when the clutch is engaged, in particular during the operating status of recuperation, a torsional moment transmission is possible in the opposite direction, i.e., from the drive shaft to the rotor arm. Using abrasively closing clutch states, it is possible to gradually vary the transferred torsional moment. If the clutch is disengaged, the rotor arm is able to rotate freely relative to the drive shaft, so that no torsional moment is transferred. Accordingly, a bearing is also preferably provided in the supporting element for the rotatable bearing of the drive shaft; preferably a roller or needle bearing. The rotor arm, which comprises the support pot on one side and the supporting element on the other side, is then totally free to rotate with respect to the drive shaft when the clutch is disengaged.

It is possible for the drive shaft to be formed in one part. This results in two points of contact for the drive shaft in the rotor arm, i.e., in the hub on one side and in the supporting element on the other side. In another exemplary embodiment, it is possible for the drive shaft to be formed of several parts, in particular in two parts. It preferably comprises a shaft element on the input side and a shaft element on the output side. In the process, the shaft element on the input side is preferably mounted in the hub of the support pot, whereas the shaft element on the output side is preferably mounted in the supporting element. It is possible for roller or needle bearings to be provided for this purpose in the hub and/or in the supporting element. The shaft element on the input side is preferably not connected to the shaft element on the output side and can only be brought into an operative connection with this via the clutch. Typically, the shaft element on the output side in well-known electrical machines is not mounted in the support pot, but only in a housing of the electrical machine or in gearbox housing. It is therefore not possible to guarantee concentricity between the shaft element on the output side and the shaft element on the input side or the rotor arm. As a result of this, imbalances may arise in particular. However, for the rotor arm described here, the input-side and output-side shaft element are mounted in the rotor arm, in particular in the hub as well as in the supporting element, so that, on the whole, the drive shaft is mounted in two positions in the rotor arm. As a result, it is possible to guarantee concentricity between both shaft elements relative to each another and, more particularly, also relative to the rotor arm, so as to reduce or, if possible, completely avoid imbalances.

It is possible for the clutch to be connected non-rotatably to the support pot only in the region of the hub. It is preferably fixed onto the bottom of the support pot in addition to this. On the other hand, one end of the clutch which is turned away from the hub can remain free. This is particularly unproblematic for smaller electrical machines. However, for larger electrical machines, in particular for those that transfer higher torsional moments, vibrations or imbalances can occur due to the free end of the clutch. As a result, the clutch can also preferably be mounted in the supporting element in order to also support it in two places in the rotor arm which are spaced apart axially from each other. The clutch is preferably mounted for rotation in the supporting element on its end which is turned away from the hub, preferably in a roller or needle bearing.

In addition, with a two-part shaft, it is possible for the drive shaft to have a roller or needle bearing, in which the drive shaft is mounted for rotation, for example, by means of a pivot. The coaxial alignment is additionally secured in this way. An inverted design is of course also possible, in which the drive shaft is mounted for rotation in a roller or needle bearing of the output shaft.

Finally, the support pot preferably also comprises a bearing in the region of the hub, with which it itself, for example, is mounted in a gearbox housing or in a housing of the electrical machine. This bearing is also preferably formed as roller or needle bearing or locating bearing.

All of the bearings mentioned here are preferably formed as radial bearings. It is possible for at least one of the bearings mentioned here to be formed as an axial bearing at the same time. Particularly preferably, all of the bearings mentioned here are formed as both radial and axial bearings.

A rotor arm is preferred, which is characterized in that the end stop of the support pot is provided on an end which is turned away from the hub. This ensures that the supporting element is also provided on an end of the support pot which is turned away from the hub, wherein the drive shaft and possibly the clutch too—as seen in the axial direction—is/are supported in regions arranged as far apart from one another as possible. This increases the stability of its bearing.

The rotor arm is preferably of a cylindrically symmetrical form. An axial direction refers here and in the following to a direction which is parallel to an axis of symmetry of the rotor arm. A peripheral direction refers to a direction which coaxially circulates around the axis of symmetry. A radial direction refers to a direction which is perpendicular to the axial direction.

A rotor arm is preferred that is characterized in that the support pot is substantially of cylindrical form, with the end stop being arranged in the region of an annular collar, and with the annular collar having the form of a conical extension. In particular, the annular collar is provided on an end of the support pot that is turned away from the hub. A peripheral wall of this thus expands conically in its end region which is turned away from the hub, by means of which the annular collar is formed. In this region, the end stop is preferably provided as a recess on an inner peripheral surface of the support pot.

A rotor arm is preferred that is characterized in that an annular groove is provided in the inner peripheral surface of the support pot, at an axial distance to the end stop, which receives a fastening element. This induces an axial fixing of the supporting element together with the end stop. In the process, the axial distance of the annular groove to the end stop preferably approximately corresponds to a thickness of the supporting element. The fastening element is preferably formed as a snap ring. In the assembled state, the supporting element is preferably fixed on one side on the end stop and on the other side on the fastening element, using pre-stressing or clamping, such that it is fixed—as seen in the axial direction. The support pot preferably has a recess in its front side that is turned away from the hub, into which the ends of the fastening element, which is formed as a snap ring, can be inserted using suitable pliers. The recess is preferably formed in such a way that the corresponding snap ring ends do not protrude over the front side of the support pot and also not over its outer peripheral surface.

In a preferred exemplary embodiment, the rotor arm has an additional supporting element, which is preferably formed as a cover plate for the support pot, and which—as seen in the axial direction—is provided relative to the hub on the side of the supporting element, but with a larger axial distance to the hub than this. It further bears the drive shaft. In the process, a three-point bearing is preferably implemented in the case of a monobloc drive shaft because the drive shaft is mounted in the hub, in the supporting element and in the additional supporting element. If the shaft has several parts, in particular a shaft element on the input side and a shaft element on the output side, the shaft element on the input side is preferably mounted in the hub, whereas the element on the output side is mounted in the supporting element and in the additional supporting element. This results in a two-point bearing for the shaft element on the output side. Overall, this results in a particularly stable bearing of the drive shaft in the rotor arm by means of the additional supporting element.

Provision is preferably made for the additional supporting element—as seen in axial direction—to be arranged directly behind the supporting element. The supporting element is therefore initially placed on the end stop, with the additional supporting element then being placed on the supporting element. Finally, both elements are preferably fixed with a fastening element incorporated in the annular groove, which can be formed as a snap ring. In this case, the axial distance of the annular groove to the end stop preferably approximately corresponds to a sum of the thicknesses of the supporting element on one side and of the additional supporting element on the other side. In the assembled state, the supporting element and the additional supporting element are preferably located on the end stop on one side and on the fastening element on the other side, using pre-stressing or clamping, such that they are fixed—as seen in the axial direction.

A rotor arm is preferred that is characterized in that a radial bore to receive a securing element is arranged in a peripheral wall of the support pot—as seen in the axial direction—at the level of the supporting element, so that the securing element can be guided through the radial bore. Fixing the supporting element can be carried out in this way—as seen in the peripheral direction. For this purpose, the supporting element preferably has a radial recess in the form of a hole or a groove extending in the axial direction provided in its outer peripheral surface, into which the securing element can be inserted, if it is guided through the radial bore in the peripheral wall of the support pot. The securing element then prevents a relative rotation between the supporting element and the support pot, such that this is fixed—as seen in the peripheral direction—in a predefined angular position. The securing element can be formed as a pin, as a screw or in another suitable way. The radial bore pushes the peripheral wall of the support pot, so that the securing element can be inserted into it from the exterior and can push through it, so that it ultimately engages with the radial recess of the supporting element.

The support pot preferably has at least one oil passage bore in a region of its inner peripheral surface, which is located opposite a periphery of the supporting element or which is in contact with an exterior periphery surface of the supporting element, in order to be able to direct oil out to the surface. In the assembled state, this is preferably aligned with at least one oil passage bore provided in the supporting element. Oil emerging from the bearing in the supporting element ultimately reaches the oil passage bore in the supporting element via various oil guiding elements provided on the supporting element and thus the oil passage bore in the support pot. From there it arrives at an external side of the support pot, where it is fed into an oil supply system and/or an oil collection tank. Further oil passage bores are preferably provided on a base of the support pot that contains the hub, wherein they can be arranged radially on the exterior and/or radially further towards the inside of the hub. Different oil passage bores can therefore be of different sizes.

Longitudinal grooves are preferably introduced into an exterior peripheral surface of the support pot. These preferably partition the peripheral surface and serve for the alignment and mounting of the at least one magnetic element, in particular the stacks of sheets which are preferably applied to the outer periphery of the support pot. Various arrangement possibilities for the at least one magnetic element preferably arise as a result of the longitudinal grooves. It is hereby possible to achieve different power ratings of the electrical machine via the precise design of the support pot or via a variation in the number and/or order of magnetic elements arranged on the support pot. In particular, a modular design of the electrical machine is possible. The longitudinal grooves thereby also serve to secure a function of the magnetic elements.

The hub is preferably formed as one piece with the support pot. It preferably has an external toothing system as a retainer for a clutch, with which an internal toothing system of a multiple disc clutch preferably engages in the assembled state.

A support pot for a rotor arm having at least one of the features addressed here in relation to the rotor arm is also preferred. According to this, the support pot is suitable for use in such a rotor arm, so that the advantages addressed in relation to the rotor arm are implemented.

Exemplary embodiments of the invention are also directed to a method for the production of a rotor arm.

The method comprises the production of a preliminary shape of a support pot having a hub, wherein the preliminary shape is produced by flow forming (flow forming method) from a blank. For flow forming, an end stop is produced for a supporting element, with the end stop being formed by flow forming. The end stop is preferably formed in the region of a flange-like, preferably conical extension of a peripheral wall of the support pot. A flow forming method provides a very sophisticated means to form the support pot of a rotor arm with narrow tolerances, in a highly precise and integral manner. Likewise, it is readily possible to form the end stop for the supporting element on the inner peripheral surface of the support pot directly during flow forming, in an axial direction from the hub. No further method steps are required here. In particular, with the aid of flow forming, it is possible to form the preliminary shape of the support pot in such a way that it already substantially corresponds to a final shape. Subsequent processing steps that are necessary to ensure functionality and adherence to the tolerance requirements regarding the rotor arm described above, in particular cutting finishing, are shortened by this, and very little material must be removed in order to arrive at the final shape from the preliminary shape. On the one hand, this saves material and on the other hand improves the strength and the mechanical capacity of the support pot, because a fiber flow in this is only slightly disturbed by the cutting method if very little material is removed. It is therefore possible to guarantee or improve the local basic strength and/or the total strength and thus the mechanical capacity of the support pot. Moreover, particularly low tolerances can be produced in this way, so that, on the whole, the advantages described above in relation to the rotor arm can be achieved.

A method is preferred that is characterized in that the blank is produced using solid forming, preferably as a forged part, preferably by means of drop forging. If a forging process, forging or a forged part is referred to in the following, this simply serves as an abbreviation; a solid forming or a solid formed part is always included in this, wherein forging or a forged part is preferably referred to, particularly preferably drop forging or a part produced by means of drop forging. A rough shape of the hub is preferably formed in the forged part. The preliminary shape of the hub is then produced from the rough shape during flow forming. Alternatively, it is possible for the preliminary shape of the hub to be produced during forging. Alternatively, it is also possible to shape the hub initially during flow forming. Also, a base geometry of the support pot can even be roughly preformed during forging. Forging the blank thereby has the advantage that a fiber flow can already be placed in the blank, in such a way that, during later ironing, disconnection of the fibers does not take place. Due to the homogeneity induced by forging and the compression of the material, which remains intact using the further procedural steps, the support pot has a high mechanical capacity. In particular, during forging, it is possible to optimize the fiber flow to the mechanical capacities that can be expected. As a result, it is possible to compress fibers in regions with high mechanical capacity, such that these regions can be formed with thin walls, wherein they are mechanically very stable at the same time. During forging, it is also readily possible to form locally varying wall thicknesses or cross sections which are suitable for the capacity so that the cross section or the wall thickness does not have to be constantly constructed to a maximum mechanical capacity in every area. According to this, forged parts or parts flow formed from forged blanks, i.e. produced with the aid of a hybrid forging process, can generally be formed with thin walls and in the local area with very thin walls, without the mechanical capacity suffering from this. This accommodates the lightweight design. In particular, the advantages of the forged blank during flow forming remain limited. Ultimately, a rotor arm can be produced which has thin walls and is light, as well as having a mechanical high capacity.

A method is preferred that is characterized in that the blank is machined before flow forming. In particular, at least one front side of the blank is machined in order to guarantee a clean, consistent attachment for the flow forming mandrel or an optimal clamp in the flow forming machine. Preferably, both front sides of the blank are machined. Preferably, it is also possible for a peripheral surface, preferably an outer as well as an inner peripheral surface of the blank, to be machined before flow forming. In particular, it is already possible to largely finish the inner diameter of the blank before flow forming, wherein high surface quality is achieved. Additionally or alternatively, is it also possible to achieve correspondingly high surface quality through repositioning with flow forming. In preference, an inner surface of the base of the support pot is also machined before flow forming, preferably finish turned.

After machining, the support pot is flow formed with the hub, wherein a length of the pot, which is measured in axial direction, is adjusted or generated depending especially on the demand of the necessary modularization system. Moreover, during flow forming, preferably on the pot end that is turned away from the hub, the flange-like conical extension is created by formation of a wall thickening which also has the end stop.

A method is also preferred that is characterized in that the preliminary shape is finished with a cutting process to produce a final shape of the support pot. The finishing process especially comprises a rotation, cutting, drilling and/or deburring. In particular, various functions and/or oil passage bores are produced in the process. An outer peripheral surface of the support pot is preferably over-tightened to create a contact and/or frictional surface for the at least one magnetic element, in particular the stack of sheets. Axial grooves are preferably incorporated in the same way in the outer peripheral surface, via which the at least one magnetic element or the stack of sheets can be attached to the support pot in a non-slip and pre-fixed manner, wherein they are aligned for final assembly.

The finishing process preferably also comprises the production of a plug-in toothing connection on the hub by means of gear shaping or toothing driving, wherein the clutch for the drive shaft is inserted in a later method step onto the plug-in toothing connection. Alternatively or additionally, a profile roll of the plug-in toothing connection can take place before or after flow forming or even after finishing.

The toothing system is preferably hardened in order to increase its wear resistance. Alternatively, hardening can also be dispensed with in the case of a flow-forming profile due to strain hardening.

Finally, a method is preferred that is characterized in that a supporting element is arranged in the region of the end stop. As a result of this, the rotor arm is completely finished, which—as already suggested—comprises the support pot as well as the supporting element. The supporting element is thereby preferably formed as a supporting disc, which locks the support pot to its end which is turned away from the hub.

### BRIEF DESCRIPTION OF THE DRAWING FIGURES

The invention is illustrated in greater detail below by means of the drawing. Here are shown:

FIG. 1 a three-dimensional view of an exemplary embodiment of a support pot, wherein an interior is facing the observer, and

FIG. 2 a three-dimensional view of an exterior of the support pot according to FIG. 1.

### DETAILED DESCRIPTION

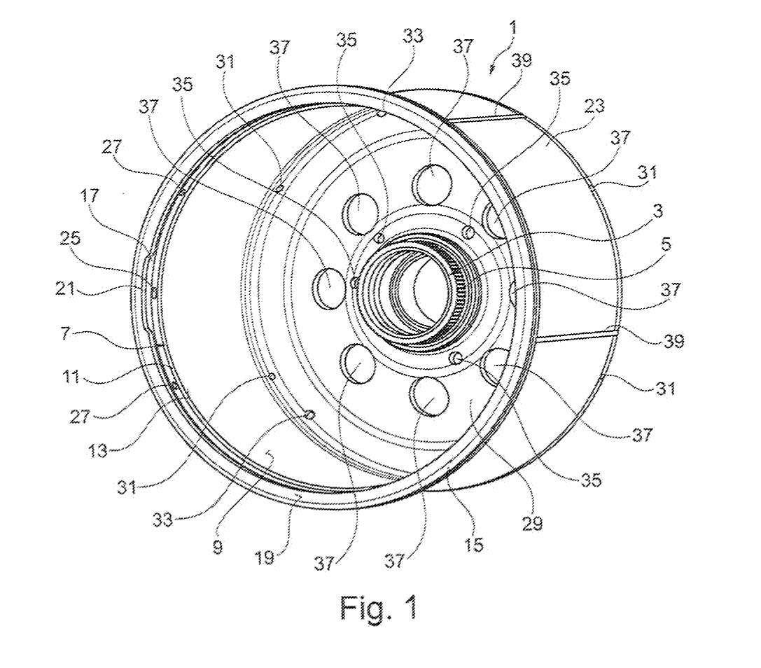

FIG. 1 shows a three-dimensional view of an exemplary embodiment of a support pot 1, wherein its interior is facing the observer. It has a hub 3 to bear a drive shaft which is not shown, wherein a roller or needle bearing is pressed into the hub 3 in the assembled state, with which the drive shaft is connected rotatably with the support pot 1. The drive shaft is preferably mounted axially and/or radially in the hub 3.

The hub 3 has a retainer 5 for a clutch on its outer peripheral surface, which is formed here as a plug-in toothing connection. In the assembled state, a multiple disc clutch is preferably attached to the plug-in toothing connection 5 with a corresponding internal toothing system. In the process, the clutch non-rotatable couples the support pot 1 with the drive shaft.

An end stop 7 is provided on an end of the support pot 1 that is turned away from the hub 3, which is formed here as a recess of an inner peripheral surface 9 of the support pot 1. In the exemplary embodiment described above, an inner diameter of the support pot 1 increases on a side of the end stop 7 that is turned away from the hub 3, such that—as seen in the peripheral direction—a circumferential ledge 11 is formed, against the surface 13 of which the supporting element rests in the assembled state of the rotor arm.

From FIG. 1 it is clear that the support pot 1 is substantially formed cylindrically. The end stop 7 is thereby arranged in the region of an annular collar 15, wherein this has the form of a conical extension opening towards the observer.

Both the annular collar 15 and the ledge 11 are preferably incorporated into the preliminary shape of the support pot 1 during flow forming. However, it is also possible for only the annular collar 15 to be incorporated into the preliminary shape of the support pot 1 during flow forming, whereas the ledge 11 is subsequently incorporated into the inner peripheral surface 9, in particular using a cutting process.

In an axial distance from the end stop 7, an annular groove 17 is inserted into the inner peripheral surface 9, which serves for the incorporation of a fastening element that is formed as a snap ring. For this purpose, the annular collar 15 has a recess 21 in its front side 19, into which the ends of the snap ring can be inserted by means of suitable pliers.

Overall, the following is evident: In order to complete the rotor arm, a supporting element that is preferably formed as a supporting disc—in FIG. 1 from an angled front view—is incorporated into the interior of the support pot 1, wherein it fastens on the end stop 7. Subsequently, a fastening element that is preferably formed as a snap ring is introduced into the groove 17, wherein its ends are received by the recess 21. The supporting element is then—as seen in the axial direction—fixed between the end stop 7 and the snap ring. Here, the axial distance between the annular groove 17 and the end stop 7 preferably corresponds approximately to the thickness of the supporting element. Provision is particularly preferably made for the supporting element to be particularly preferably held under clamping or pre-stressing between the snap ring and the end stop 7. Accordingly, the axial distance between the annular groove 17 and the end stop 7 is preferably formed to be slightly smaller, as it corresponds to the thickness of the supporting element.

In a peripheral wall 23 of the support pot 1—as seen in the axial direction—a radial bore 25 is formed at the level of the supporting element, which forces through the peripheral wall 23. This serves to receive a securing element, which is preferably formed as a pin or a screw. In the assembled state, this engages with a radial recess of a peripheral wall of the supporting element, such that this—as seen in the peripheral direction—is fixed in a predefined position relative to the support pot 1. In this position, the oil passage bores provided in the peripheral wall of the supporting element are preferably aligned with the bores 27 provided in the peripheral wall 23 of the support pot 1, which preferably serve as oil passage bores. In particular, oil emerging from the interior of the support pot 1 can be taken away through this from the bearing for the drive shaft provided in the supporting element and led towards an oil supply system and/or an oil collection tank.

The support pot 1 has a base 29, via which the hub 3 is connected to the peripheral wall 23. In the base region 29, further oil passage bores and/or installation auxiliary bores, are preferably provided, for example to fasten onto a hybrid head. In the exemplary embodiment described above, however, small bores 31 are arranged in a transition region between the peripheral wall 23 and the base 29, through which oil emerging in the support pot 1, which rotates when operating, can be forced out, in particular with the aid of centrifugal force.

Alternatively or additionally, it is possible for at least one of the bores 31 to be able to be used for fastening, for example by means of riveting, a spacer, spacing and/or cover ring, for different arrangements of magnetic elements in order to protect them against axial position changes. As a consequence, a modular construction of the electrical bundle that comprises the magnetic elements is attainable. The different arrangement of the magnetic elements preferably takes place depending on a performance requirement for the electrical machine.

On an outer edge of the base 29, slightly larger bores 33 are arranged, through which oil can also pass, which is directed onto the edge of the base due to the centrifugal force.

Alternatively or additionally, the bores 33 can also be implemented as thread holes, which serve for the outer installation of an oil paddle wheel. This preferably enables controlled oil transport.

Finally, bores 35 are preferably also arranged as oil passage bores that are directly adjacent to the hub and coaxial to these bores, which are, in turn, slightly larger than the bores 33.

Alternatively or additionally, it is possible for the bores 35 to be provided as installation bores or installation auxiliary bores, for example to fasten onto a hybrid head.

Likewise, coaxially to the hub 3, yet at a greater radial distance to this, comparatively large recesses 37 are arranged in a circle in this case, which preferably force through the base 29. On the one hand, these serve for weight reduction, because, here, material from the pot base 29 is removed. On the other hand, they can be used as assembly and/or disassembly openings, with which a special tool can engage. In addition to this, it is also possible for the recesses 37 to serve as further oil passage bores.

Preferably, all bores 27, 31, 33, 35 provided on the support pot 1, as well as the recesses 37, are provided concentrically to the hub 3 and are equally distributed, thus in particular at equal angular distance to one another. They are also as symmetrical as possible, preferably exactly symmetrically distributed around an axis of rotation of the support pot 1, such that, if possible, any imbalances are avoided a homogeneous mass distribution results.

Longitudinal grooves 39 are incorporated into the outer peripheral wall 23, which are also preferably provided at constant angular distance to one another and are symmetrically distributed on the peripheral wall 23. These serve for the alignment and mounting of magnetic elements arranged on the peripheral wall 23, in particular of stacks of sheets provided with permanent magnets. It is also possible to insert spacer rings here in order to implement different performance categories for the electrical machine or to fix the magnetic elements. This corresponds to a modularization concept, in which spacer rings can preferably be exchanged for magnetic elements, in order to achieve different power ratings. In particular, these can be pre-fixed with anti-slip with the aid of the longitudinal grooves 29, such that they are aligned for a final assembly.

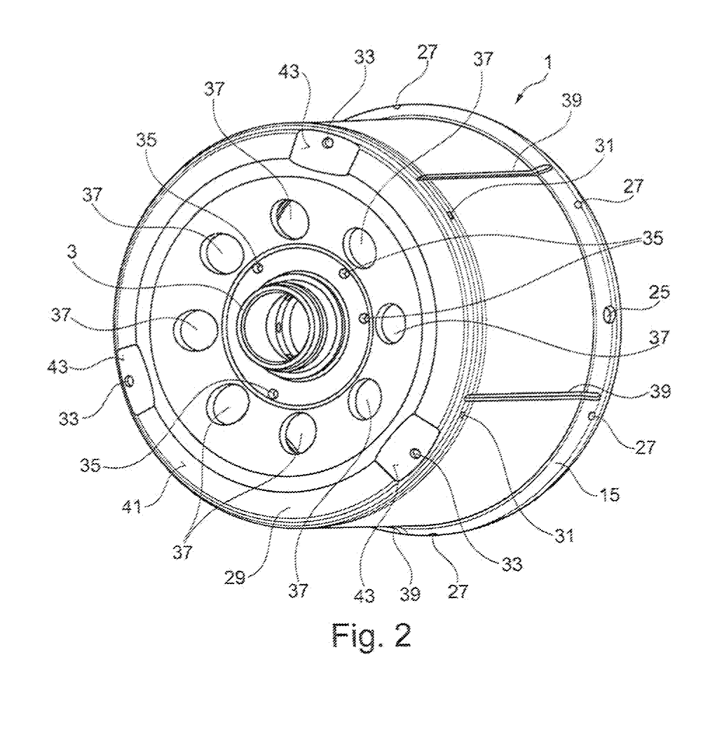

FIG. 2 shows a rotated view of the support pot 1 according to FIG. 1, so that an exterior of this is facing the observer. The same elements and elements with the same function are provided with the same reference numerals, so as to reference the preceding description in this respect. It is clear that the annular collar 15 expands conically towards the exterior, viewed in the direction facing away from the hub 3.

The hub 3 preferably has a bearing location on its outer periphery to bear the support pot 1. The support pot 1 can also be mounted, for example, in a gearbox.

In the region of the bores 33, an outer surface 41 of the base 29 is plane machined, such that contact surfaces 43 are formed around the bores 33. The bores 33 preferably serve as installation bores for an oil paddle wheel. This can, at least in certain areas, be securely and firmly placed on the contact surfaces 43.

It is possible to arrange compensation elements on the outer surface 41 to reduce imbalances. The support pot 1 can be balanced, for example by applying material on the outer surface 41, for example by soldering, or by providing balancing bores or balancing recesses—preferably placed next to one another—in the outer surface 41.

The support pot 1 is preferably produced by initially producing a blank, preferably as a forged part, which already has a rough shape of the hub 3 and preferably also a rough shape of the geometry of the base 29. This blank is pre-turned in order to enable a clean, consistent attachment in the flow forming machine and in particular on a flow forming pin. At the same time, the inner diameter or the inner peripheral surface 9 is largely machined, with a high surface quality being achieved. The base geometry of the base 29 is preferably already largely completed during this machining.

Subsequently, the support pot 1 is flow formed with the hub 3, wherein the pot length is adjusted according to demand. At the same time, the annular collar 15 is created by formation of a wall thickening. The ledge 11 can preferably be produced during flow forming, but also during a subsequent cutting processing step.

Following flow forming, the preliminary shape of the support pot 1 is completed using a cutting process to produce a final shape. The cutting process preferably comprises a rotation, cutting, drilling and/or deburring, wherein other cutting methods can be included. In particular, the different recesses 21, 37, the radial bore 25, the bores 27, 31, 33, 35 and the longitudinal grooves 39, as well as the annular groove 17 where necessary, are formed in the process.

Finally, the hub 3 is provided on its side facing the inside of the support pot 1 with a plug-in toothing connection by means of gear shaping or toothing driving. The toothing system should preferably finally be hardened, in order to increase its wear resistance. Alternatively, it is also possible to profile the hub before flow forming.

Overall, it is evident that, with the aid of the rotor arm and the method for the production thereof, a clear reduction in performance losses and performance fluctuations within a series of electrical machines is possible. In particular, a particularly good running quality, cylindricity and circularity of the support pot 1 can be achieved with the help of flow forming, so as to reduce, or preferably avoid imbalances. In addition, imbalances are avoided, in that the drive shaft is mounted not only in the region of the hub 3, but also in the region of the supporting element in an axial direction to hub 3. Through the combination of flow forming with a forging process, it is possible to produce a rotor arm, which has thin walls, is light and also has a high mechanical load capacity at the same time. In the process, the strength of the support pot 1 can be adjusted by the degree of deformation and by the design of the pre-form. Alternatively or additionally, a further improvement to the process reliability for flow forming can also be achieved through structure treatment, in particular a heat treatment following solid forming or forging.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A rotor arm for an electrical machine, the rotor arm comprising:
a support pot configured for mounting at least one magnetic element, wherein the support pot comprises
a hub bearing a drive shaft,
an inner peripheral surface with an end stop at an axial distance from the hub, wherein the end stop is configured to receive a supporting element of the rotor arm as a further bearing of the drive shaft.

12. The rotor arm of claim 11, wherein the end stop is provided on an end of the support pot that faces away from the hub.

13. The rotor arm of claim 11, wherein the support pot is cylindrical, wherein the end stop is arranged in a region of an annular collar in a shape of a conical extension.

14. The rotor arm of claim 11, wherein an annular groove is arranged in the inner peripheral surface of the support pot to receive a fastening element at an axial distance from the end stop, wherein the fastening element induces an axial fixing of the supporting element together with the end stop, and wherein the axial distance between the annular groove and the end stop corresponds to a thickness of the supporting element.

15. The rotor arm of claim 11, wherein a radial bore configured to receive a securing element is arranged in a peripheral wall of the support pot, as seen in an axial direction, at a level of the supporting element, such that, as seen in a peripheral direction, a securing element passing through the radial bore fixes the supporting element.

16. A support pot of a rotor arm for an electrical machine, wherein the support pot is configured for mounting at least one magnetic element, wherein the support pot comprises:
a hub bearing a drive shaft,
an inner peripheral surface with an end stop at an axial distance from the hub, wherein the end stop is configured to receive a supporting element of the rotor arm as a further bearing of the drive shaft.

17. A method for the production of a rotor arm, the method comprising:
producing a preliminary shape of a support pot having a hub made from a blank using flow forming,
wherein, during flow forming and via flow forming, an end stop is formed for a supporting element in a conical extension of a peripheral wall of the support pot.

18. The method of claim 17, wherein blank is produced as a forged by drop forging, and wherein a rough contour of the hub is formed in the forged part.

19. The method of claim 17, wherein the blank is machined before flow forming.

20. The method of claim 17, wherein the preliminary shape is finished with a cutting process to produce a final shape of the support pot.
